(19) United States
(12) Patent Application Publication
(10) Pub. No.: US 2026/0316416 A1
(43) Pub. Date: Oct. 15, 2026

(54) PACKAGING MATERIAL PRODUCTION MACHINE AND SYSTEM CONSISTING OF A PACKAGING MATERIAL PRODUCTION MACHINE AND A PACKAGING MATERIAL SUPPLY

(71) Applicant: Sprick GmbH Bielefelder Papier- und Wellpappenwerke & Co., Bielefeld (DE)

(72) Inventors: Bastian SCHALK, Detmold (DE); Vitali KREBS, Ahlen (DE); Erik ALBERT, Horn-Bad Meinberg (DE)

(21) Appl. No.: 19/478,060

(22) PCT Filed: Apr. 24, 2024
(86) PCT No.: PCT/EP2024/061282

§ 371 Date: Oct. 23, 2025

(30) Foreign Application Priority Data
Apr. 24, 2023 (DE) 10 2023 110 436.5

(51) Int. Cl. B31D 5/00

(52) U.S. Cl. CPC B31D 5/0047; B31D 5/0052; B31D 2205/0029; B31D 2205/0047; B31D 2205/0058; B31D 2205/0082

(57) ABSTRACT

The present invention relates to a packaging material production machine for producing a packaging material product, comprising a feed for introducing packaging material, in particular from a packaging material web wound up to form a roll, from the roll inner side thereof, with a deflection roller oriented transversely, in particular perpendicularly, to the direction of introduction of the packaging material web into the packaging material production machine and a guide wall arranged at a lateral end, in particular an end face, of the deflection roller for deflecting the packaging material web in the direction of the deflection roller.

The present invention relates to a packaging material production machine for producing a packaging material product from a packaging material supply, which comprises at least one packaging material web wound up to form a roll, in particular of paper, board or the like, in particular used paper and/or 100% recyclable used paper without chemical ingredients. Furthermore, the present invention relates to a system consisting of a generic packaging material production machine and a packaging material supply consisting of a packaging material web wound up to form a roll, in particular of paper, board or the like, which can be drawn off from a roll inner side.

Generic packaging material production machines generally comprise a feed for feeding or introducing the packaging material into a forming device which serves to form the web-shaped packaging material into a voluminous, upholstered packaging material product, and a downstream delivery and/or cutting-to-length device.

Such a packaging material production machine is known from DE 10 2019 135 629A1, which comprises a multi-part housing, wherein in a first housing part the feed and a funnel-like housing structure are arranged for concentrated feeding of the packaging material to the further housing part arranged downstream, in which the forming device is arranged, which is configured to form the packaging material web arriving as a tubular packaging material web intermediate product into an in particular three-dimensional, voluminous and upholstered packaging material product by means of an embossing and/or punching device for introducing embossings and/or perforations into the material web. Furthermore, the delivery and/or cutting-to-length device for cutting packaging material products of desired length to length from the web-shaped or tubular packaging material strand is accommodated in the rear housing part.

Against the background of the increasing space pressure and the endeavor to produce packaging material products which cushion well in an ever narrower space, there is a challenge in producing packaging material products reliably and quickly in a small space, that is to say in particular at short distances, without web tears or paper jamming occurring. DE 10 2019 135 629 A1 does indeed offer a reliable feed with avoidance of web tears and paper jamming of the packaging material into the machine via an upstream deflection roller with two lateral conical end sections which ensure that the packaging material web is introduced into the machine in a flexible manner centred from a wide variety of directions. However, it has been found that such a construction is indeed very helpful with regard to the avoidance of web tears and paper jamming, but does not meet the increasing demands on the space problem.

An object of the present invention consists in overcoming the disadvantages from the prior art, in particular reliably avoiding a web tear and/or paper jamming even in miniaturized packaging material product machines.

The object is solved by the subject matter of the independent claims.

Accordingly, a packaging material production machine for producing a packaging material product is provided. A packaging material product may, for example, have a tubular, screw, and/or cushion-cushion-like shape and/or gathered strand shape.

The packaging material production machine according to the invention comprises a feed for introducing packaging material, in particular from a packaging material web wound up to form a roll, from the roll inner side thereof, with a deflection roller oriented transversely, in particular perpendicularly, to the direction of introduction of the packaging material web into the packaging material production machine and a guide wall arranged at a lateral end, in particular end face, of the deflection roller for deflecting the packaging material web in the direction of the deflection roller.

The packaging material web can be produced from paper, such as recycled paper, in particular used paper and/or 100% recyclable paper, which can be produced without chemical ingredients. Recycled paper are in particular paper materials with a small proportion (less than 50%) of paper material containing fresh fibers. For example, paper materials which contain 70% to 100% used paper are used. The recycled paper in the sense of this invention can be paper material which can have a tensile strength index longitudinally to the machine running direction of at most 90 Nm/g, preferably a tensile strength of 15 Nm/g to 60 Nm/g, and can have a tensile strength index transversely to the machine running direction of at most 60 Nm/g, preferably a tensile strength of 5 Nm/g to 40 Nm/g. A standard DIN EN ISO 1924-2 or DIN EN ISO 1924-3 can be used to determine the tensile strength or the tensile strength index. In addition or alternatively, a recycled paper property or used paper property can be characterized by the so-called burst resistance. A material in this sense is recycled paper with a bursting index of at most 3.0 kPa*m\hat{ }2/g, preferably with a bursting index of 0.8 kPa*m\hat{ }2/g to 2.5 kPa*m\hat{ }2/g. The standard DIN EN ISO 2758 is used to determine the bursting index. Furthermore, the packaging material has a mass per unit area of in particular 40 g/m2 to at most 140 g/m2. The starting packaging material is present in the form of a material web roll which has a cylindrical basic shape and is deposited on the end side on a support, with the result that the roll can be drawn off from the roll interior.

The deflection roller can be in idling mode. For example, the deflection roller is not driven by a motor or a similar drive component, but rather rotates exclusively as a result of frictional contact with the packaging material deflected by the deflection roller. For example, in this case a particularly low-friction mounting for the deflection roller can be provided, for example by selecting a low-friction material pairing, by lubrication and/or by producing a lubricating film, in particular in the case of full lubrication. It is also possible for the deflection roller to be driven and/or to be used for conveying and drawing in the packaging material web into the packaging material production machine. The deflection roller can moreover also be arranged rigidly without a rotational degree of freedom of movement and be realized, for example, by a particularly smooth surface by which the frictional contact with the packaging material web to be deflected is particularly reduced.

The guide wall arranged at the lateral ends of the deflection roller, in particular in each case a guide wall arranged at a respective lateral end of the deflection roller, has the advantage that an incoming packaging material web can be introduced into the packaging material production machine in a better or more targeted manner. As a result of the concerted guidance or deflection by means of the guide wall in the direction of the deflection roller, which is in turn responsible for the concerted further guidance of the packaging material web into the interior of the packaging material production machine, web tear-offs can be avoided. In particular, a collision with sharp edges, transitions or other housing parts is avoided. For example, the guide wall is shaped such that a feed of the packaging material web to the deflection roller which is as continuous or uniform as possible is ensured without providing excessively strong deflections.

According to a further aspect of the present invention, which can be combined with the preceding aspects and exemplary embodiments, a packaging material production machine for producing a packaging material product is provided.

The packaging material production machine according to the invention comprises a feed for introducing packaging material, in particular from a packaging material web wound up to form a roll from the inner side of the roll, with a deflection roller oriented transversely, in particular perpendicularly, to the insertion direction of the packaging material web into the packaging material production machine.

The packaging material web can be produced from paper, such as recycled paper, in particular used paper and/or 100% recyclable paper, which can be produced without chemical ingredients. Recycled paper includes in particular paper materials with a low proportion (less than 50%) of paper material containing fresh fibers. For example, paper materials which contain 70% to 100% used paper are used. The recycled paper within the meaning of this invention can be paper material which can have a tensile strength index longitudinally with respect to the machine running direction of at most 90 Nm/g, preferably a tensile strength of 15 Nm/g to 60 Nm/g, and can have a tensile strength index transversely with respect to the machine running direction of at most 60 Nm/g, preferably a tensile strength of 5 Nm/g to 40 Nm/g. A standard DIN EN ISO 1924-2 or DIN EN ISO 1924-3 can be used to determine the tensile strength or the tensile strength index. In addition or alternatively, a recycled paper property or waste paper property can be characterized by the so-called burst resistance. A material in this sense is recycled paper with a bursting index of at most 3.0 kPa*m\hat{ }2/g, preferably with a bursting index of 0.8 kPa*m\hat{ }2/g to 2.5 kPa*m\hat{ }2/g. The standard DIN EN ISO 2758 is used to determine the bursting index. Furthermore, the packaging material has a mass per unit area of in particular 40 g/m2 to at most 140 g/m2. The starting packaging material is present in the form of a roll of material web which has a cylindrical basic shape and is deposited on the end face on a support, such that the roll can be drawn off from the roll interior.

The deflection roller can be idle. For example, the deflection roller is not driven by a motor or a similar drive component, but rather rotates exclusively as a result of frictional contact with the packaging material deflected by the deflection roller. For example, in this case a particularly low-friction mounting for the deflection roller may be provided, for example by selecting a low-friction material pairing, by lubrication and/or by generating a lubricating film, in particular in the case of full lubrication. It is also possible for the deflection roller to be driven and/or to be used for conveying and drawing in the packaging material web into the packaging material production machine. Moreover, the deflection roller can also be arranged rigidly without a rotational degree of freedom of movement and can be realized for example by a particularly smooth surface, by means of which the frictional contact with the packaging material web to be deflected is particularly reduced.

According to the further aspect according to the invention, the deflection roller has a lateral end section which is covered by a guide wall in the conveying direction of the packaging material web. In other words, the packaging material production machine comprises a guide wall which is assigned to one, in particular both, lateral end sections of the deflection roller in such a way that the lateral end section is covered or covered or spanned by the guide wall. The covered lateral end section may make up a range from 1% to 10% of the longitudinal extent of the deflection roller. Furthermore, the guide wall can be curved, in particular convexly curved, in particular in the region in which it covers the lateral end section, such that a feed of the packaging material web to the deflection roller which avoids as uniform and strong abrupt deflection as possible is ensured.

In an exemplary embodiment of the packaging material production machine according to the invention, the deflection roller is mounted on a shaft which is supported laterally on a housing wall of the packaging material production machine. In this case, there is a bearing gap, in particular of a few millimeters, between the housing wall and a lateral end face of the deflection roller, which bearing gap is covered by the guide wall. The guide wall can be designed such that it covers in any case the bearing gap and, if appropriate, still a certain region of lateral end section region. It has been found that, in the region of the mounting of the deflection roller, if the latter is exposed, there are risks of the paper web getting caught in the bearing gap. This can advantageously be prevented by the preferred embodiment of the storage wall.

In a further exemplary embodiment of the present invention, the guide wall delimits a guide path which tapers in a funnel-like manner at least in sections in the conveying direction of the packaging material web. As a result of the tapering guide path, the concerted and desired deflection and feeding of the packaging material web to the deflection roller and thus into the interior of the packaging material production machine is conveyed.

According to a further exemplary embodiment of the packaging material production machine according to the invention, the guide wall projects beyond the deflection roller counter to the conveying direction of the packaging material web. The guide wall can thus receive the packaging material early, that is to say before a potential contact of the packaging material web with the deflection roller or other housing parts of the packaging material production machine, in order to deflect the packaging material web early into the desired orientation and into the desired direction. For example, the guide wall projects beyond the deflection roller counter to the conveying direction by at least 30%, in particular at least 40%, 50%, 60%, 70%, 80%, 90% or 100% of a diameter of the deflection roller.

In a further exemplary embodiment of the packaging material production machine according to the invention, the guide wall has a cross section which is shaped such that the guide wall follows a circle segment of at least 90°, in particular at least 135°, 180°, 225° or 270°, of a cross section of the deflection roller. The larger the region of the circumference of the deflection roller which is covered by the guide wall, the more effective is the function of the guide wall, in particular independently of the feed direction and/or the positioning of the packaging material web roll relative to the packaging material production machine. The function of the guide wall is maintained by the large-area covering of the deflection roller, to be precise independently of where the packaging material web roll is located.

According to a further exemplary embodiment of the present invention, the deflection roller has a pair of rollers delimiting a passage gap for the packaging material web. Furthermore, the guide wall is designed for deflecting the packaging material web in the direction of the passage gap. The rollers can in principle be of identical design or be mounted identically or, for example, have a different diameter, wherein it has proved to be advantageous here if the deflection roller which is lower in relation to the vertical direction has a larger diameter. The creation of a passage gap additionally has an advantageous effect on the targeted and desired introduction of the packaging material web into the packaging material production machine interior, such that the risk of a web tear-off is reduced or in particular avoided. A further improvement is achieved by the interaction of the guide wall and a pair of deflection rollers delimiting a passage gap.

According to an exemplary development of the packaging material production machine according to the invention, the guide wall in each case covers a lateral end section of the rollers in the conveying direction of the packaging material web and/or projects beyond both rollers counter to the conveying direction of the packaging material web. The guide wall thus covers a very large angular region from the feed direction of the packaging material web to the packaging material production machine and can support the concerted deflection and feeding of the packaging material web into the production machine.

According to a further aspect of the present invention, which can be combined with the preceding aspects and exemplary embodiments, a packaging material production machine for producing a packaging material product is provided.

The packaging material production machine according to the invention comprises a feed for introducing packaging material, in particular from a packaging material web wound up to form a roll from the inner side of the roll, with a deflection roller oriented transversely, in particular perpendicularly, to the insertion direction of the packaging material web into the packaging material production machine.

The packaging material web can be produced from paper, such as recycled paper, in particular used paper and/or 100% recyclable paper, which can be produced without chemical ingredients. Recycled paper includes in particular paper materials with a low proportion (less than 50%) of paper material containing fresh fibers. For example, paper materials which contain 70% to 100% used paper are used. The recycled paper within the meaning of this invention can be paper material which can have a tensile strength index longitudinally with respect to the machine running direction of at most 90 Nm/g, preferably a tensile strength of 15 Nm/g to 60 Nm/g, and can have a tensile strength index transversely with respect to the machine running direction of at most 60 Nm/g, preferably a tensile strength of 5 Nm/g to 40 Nm/g. A standard DIN EN ISO 1924-2 or DIN EN ISO 1924-3 can be used to determine the tensile strength or the tensile strength index. In addition or alternatively, a recycled paper property or waste paper property can be characterized by the so-called burst resistance. A material in this sense is recycled paper with a bursting index of at most 3.0 kPa*m\hat{ }2/g, preferably with a bursting index of 0.8 kPa*m\hat{ }2/g to 2.5 kPa*m\hat{ }2/g. The standard DIN EN ISO 2758 is used to determine the bursting index. Furthermore, the packaging material has a mass per unit area of in particular 40 g/m2 to at most 140 g/m2. The starting packaging material is present in the form of a roll of material web which has a cylindrical basic shape and is deposited on the end face on a support, such that the roll can be drawn off from the roll interior.

The deflection roller can be idle. For example, the deflection roller is not driven by a motor or a similar drive component, but rather rotates exclusively as a result of frictional contact with the packaging material deflected by the deflection roller. For example, in this case a particularly low-friction mounting for the deflection roller may be provided, for example by selecting a low-friction material pairing, by lubrication and/or by generating a lubricating film, in particular in the case of full lubrication. It is also possible for the deflection roller to be driven and/or to be used for conveying and drawing in the packaging material web into the packaging material production machine. Moreover, the deflection roller can also be arranged rigidly without a rotational degree of freedom of movement and can be realized for example by a particularly smooth surface, by means of which the frictional contact with the packaging material web to be deflected is particularly reduced.

According to the further aspect according to the invention, the packaging material production machine comprises a shaping device, arranged downstream of the deflection roller in the conveying direction, for shaping the packaging material web into a voluminous, cushioning packaging material product, in particular with at least one crumple cavity. The shaping device generally serves to shape a flat packaging material web or a tubular packaging material strand into a three-dimensional, cushioning and voluminous packaging material product.

In this case, an orientation of a conveying path from the deflection roller to the shaping device is inclined downstream of the shaping device with respect to a dispensing direction, along which the packaging material product leaves the packaging material machine, of the packaging material product. For example, the angle of inclination is up to 10°, in particular up to 7° or up to 5°. The inclination of the conveying path has an advantageous effect on the functional reliability of the packaging material production machine. It has been found that, as a result of the inclination of the conveying path from the deflection roller to the shaping device, on the one hand continuous shaping without excessively large abrupt shaping angles is promoted and, on the other hand, a certain pretensioning of the packaging material web by means of the shaping device against the shaping roller acting as a counter-bearing is nevertheless possible, as a result of which the concerted and desired conveying of the packaging material web is further promoted. In an exemplary development of the packaging material production machine, the shaping device has a pair of conveying wheels rolling against one another, in particular a preferably meshing pair of embossing and/or punching wheels, which is mounted rotatably with respect to an axis of rotation which is oriented transversely, in particular perpendicularly, to the dispensing direction. The angle of inclination is determined by a connecting straight line from a contact end point, at which the packaging material web leaves the deflection roller, to a centre of rotation of the pair of conveying wheels. It is clear that the contact end point varies depending on the orientation of the packaging material production machine in relation to the direction of gravity.

In a further exemplary embodiment of the packaging material production machine according to the invention, the packaging material production machine can assume a horizontal configuration in which the dispensing direction is oriented horizontally and the conveying path is inclined with respect to the horizontal. For example, the conveying path, starting from the deflection roller, in particular a contact end point, at which the packaging material web leaves the deflection roller, to the pair of conveying wheels, in particular a centre of rotation of the pair of conveying wheels, bridges a height difference which is, for example, in the range from 15 mm to 50 mm, in particular from 20 mm to 40 mm, or in the range from 25 mm to 30 mm. For example, a length of the conveying path between the deflection roller and the shaping device may be in the range from 200 mm to 400 mm, in particular in the range from 225 mm to 350 mm or in the range from 250 mm to 300 mm.

According to a further aspect of the present invention, which can be combined with the preceding aspects and exemplary embodiments, a packaging material production machine for producing a packaging material product is provided.

The packaging material production machine according to the invention comprises a feed for introducing packaging material, in particular from a packaging material web wound up to form a roll from the inner side of the roll, with a deflection roller oriented transversely, in particular perpendicularly, to the insertion direction of the packaging material web into the packaging material production machine.

The packaging material web can be produced from paper, such as recycled paper, in particular used paper and/or 100% recyclable paper, which can be produced without chemical ingredients. Recycled paper includes in particular paper materials with a low proportion (less than 50%) of paper material containing fresh fibers. For example, paper materials which contain 70% to 100% used paper are used. The recycled paper within the meaning of this invention can be paper material which can have a tensile strength index longitudinally with respect to the machine running direction of at most 90 Nm/g, preferably a tensile strength of 15 Nm/g to 60 Nm/g, and can have a tensile strength index transversely with respect to the machine running direction of at most 60 Nm/g, preferably a tensile strength of 5 Nm/g to 40 Nm/g. A standard DIN EN ISO 1924-2 or DIN EN ISO 1924-3 can be used to determine the tensile strength or the tensile strength index. In addition or alternatively, a recycled paper property or waste paper property can be characterized by the so-called burst resistance. A material in this sense is recycled paper with a bursting index of at most 3.0 kPa*m\hat{ }2/g, preferably with a bursting index of 0.8 kPa*m\hat{ }2/g to 2.5 kPa*m\hat{ }2/g. The standard DIN EN ISO 2758 is used to determine the bursting index. Furthermore, the packaging material has a mass per unit area of in particular 40 g/m2 to at most 140 g/m2. The starting packaging material is present in the form of a roll of material web which has a cylindrical basic shape and is deposited on the end face on a support, such that the roll can be drawn off from the roll interior.

The deflection roller can be idle. For example, the deflection roller is not driven by a motor or a similar drive component, but rather rotates exclusively as a result of frictional contact with the packaging material deflected by the deflection roller. For example, in this case a particularly low-friction mounting for the deflection roller may be provided, for example by selecting a low-friction material pairing, by lubrication and/or by generating a lubricating film, in particular in the case of full lubrication. It is also possible for the deflection roller to be driven and/or to be used for conveying and drawing in the packaging material web into the packaging material production machine. Moreover, the deflection roller can also be arranged rigidly without a rotational degree of freedom of movement and can be realized for example by a particularly smooth surface, by means of which the frictional contact with the packaging material web to be deflected is particularly reduced.

According to the further aspect according to the invention, the packaging material production machine comprises a guide device, arranged downstream of the deflection roller, which provides a reduced guide path for the packaging material web in comparison with the length of the deflection roller in the extent direction thereof and which is arranged at most at a distance of twice the deflection roller diameter from the deflection roller in the conveying direction of the packaging material web. The downstream guide device prevents an undesired buckling of the packaging material web, in particular in the region of the interior of the packaging material production machine, where for example a shaping device for shaping the packaging material web into a voluminous, cushioning packaging material product can be arranged, such that a tearing behavior and a risk of paper jamming is reduced, in particular avoided. As a result of the fact that the guide device is arranged very close to the deflection roller, the packaging material can reliably leave the deflection roller and reach the guide device and be advantageously guided thereby.

According to an exemplary development of the packaging material production machine according to the invention, the guide device is formed by a pair of guide rollers arranged at a distance from one another, which are mounted, for example, in a freewheeling manner and/or the axis of rotation of which is oriented transversely, in particular perpendicularly, to the axis of rotation. In the horizontal configuration of the packaging material production machine, the guide rollers are substantially perpendicular.

According to a further aspect of the present invention, which is combined with the preceding aspects and exemplary embodiments, a packaging material production machine for producing a packaging material product is provided. A packaging material product may, for example, have a tubular, spiral, and/or cushion-pillow-like shape.

The packaging material production machine according to the invention comprises a feed for introducing packaging material, in particular from a packaging material web wound up to form a roll from the inner side of the roll, into the packaging material production machine. The feed can have a deflection roller oriented transversely, in particular perpendicularly, to the insertion direction of the packaging material web and, if appropriate, a guide wall arranged at a lateral end, in particular end face, of the deflection roller for deflecting the packaging material web in the direction of the deflection roller. The deflection roller can be idle. For example, the deflection roller is not driven by a motor or a similar drive component, but rather rotates exclusively as a result of frictional contact with the packaging material deflected by the deflection roller. For example, in this case a particularly low-friction mounting for the deflection roller may be provided, for example by selecting a low-friction material pairing, by lubrication and/or by generating a lubricating film, in particular in the case of full lubrication. It is also possible for the deflection roller to be driven and/or to be used for conveying and drawing in the packaging material web into the packaging material production machine. Moreover, the deflection roller can also be arranged rigidly without a rotational degree of freedom of movement and can be realized for example by a particularly smooth surface, by means of which the frictional contact with the packaging material web to be deflected is particularly reduced.

The packaging material production machine according to the invention further comprises a shaping device, arranged downstream of the feed in the conveying direction, for shaping a packaging material web into a voluminous, cushioning packaging material product, in particular with at least one crumple cavity. The shaping device generally serves to shape a flat packaging material web or a tubular packaging material strand into a three-dimensional, cushioning and voluminous packaging material product.

Furthermore, the packaging material production machine comprises a dispensing device for dispensing the packaging material production product. The dispensing device may be designed as a tear-off device and/or cutting-to-length device which is capable of producing packaging material products, in particular of a desired length, or which can be used by an operator to tear off a packaging product of a certain length.

A total length of the packaging material production machine in the conveying direction of the packaging material web is less than 500 mm, in particular less than 450 mm or less than 400 mm. Alternatively or additionally, a production distance, beginning with a first deflection of the packaging material web by the packaging material production machine, in particular by the feed, to a downstream shaping of the packaging material web to form the packaging material product in the conveying direction of the packaging material web, is less than 400 mm, in particular less than 360 mm or less than 340 mm. The production distance can be understood to mean the distance which begins with the first contact of the packaging material web with the packaging material production machine, in particular the feed at which a deflection takes place, and ends at the point at which the packaging material product is completely shaped, in particular has assumed its final shape. This can be upstream of the dispensing device as viewed in the conveying direction, since the packaging material production machine can be designed such that no further shaping takes place downstream of the shaping device as far as the dispensing device and/or cutting-to-length device. A distance between the shaping device and a dispensing opening of the dispensing device, at which the packaging material product ultimately leaves the packaging material production machine, is less than 100 mm, in particular less than 90 mm, 80 mm or less than 70 mm.

One of the main motivation reasons for creating the packaging material production machine according to the invention was to create a machine which is as compact and/or small as possible and with which packaging material products which are usually dimensioned and/or of high quality with regard to the cushioning property can be produced. The inventors of the present invention have managed to create, by means of the construction according to the invention, a packaging material web guidance and a restriction to a production machine reduced to e components necessary for the packaging material product production, without having to accept losses in the quality, in particular the cushioning properties, of the packaging material products produced.

According to a further aspect of the present invention, which can be combined with the preceding aspects and exemplary embodiments, a packaging material production machine for producing a packaging material product is provided.

The packaging material production machine according to the invention comprises a feed for introducing packaging material, in particular from a packaging material web wound up to form a roll from the inner side of the roll, into the packaging material production machine. The feed can have a deflection roller oriented transversely, in particular perpendicularly, to the insertion direction of the packaging material web and, if appropriate, a guide wall arranged at a lateral end, in particular end face, of the deflection roller for deflecting the packaging material web in the direction of the deflection roller. The deflection roller can be idle. For example, the deflection roller is not driven by a motor or a similar drive component, but rather rotates exclusively as a result of frictional contact with the packaging material deflected by the deflection roller. For example, in this case a particularly low-friction mounting for the deflection roller may be provided, for example by selecting a low-friction material pairing, by lubrication and/or by generating a lubricating film, in particular in the case of full lubrication. It is also possible for the deflection roller to be driven and/or to be used for conveying and drawing in the packaging material web into the packaging material production machine. Moreover, the deflection roller can also be arranged rigidly without a rotational degree of freedom of movement and can be realized for example by a particularly smooth surface, by means of which the frictional contact with the packaging material web to be deflected is particularly reduced.

The packaging material production machine according to the invention further comprises a shaping device, arranged downstream of the feed in the conveying direction, for shaping a packaging material web into a voluminous, cushioning packaging material product, in particular with at least one crumple cavity. The shaping device generally serves to shape a flat packaging material web or a tubular packaging material strand into a three-dimensional, cushioning and voluminous packaging material product.

Furthermore, the packaging material production machine comprises a dispensing device for dispensing the packaging material production product. The dispensing device may be designed as a tear-off device and/or cutting-to-length device which is capable of producing packaging material products, in particular of a desired length, or which can be used by an operator to tear off a packaging product of a certain length.

According to the further aspect according to the invention, the packaging material production machine comprises a cover part which is produced from one piece and encloses the shaping device and the dispensing device. As a result of the one-piece structure of the cover part, in comparison with the prior art, a single injection-molding machine is sufficient if the cover part is produced from plastic. Furthermore, assembly is significantly facilitated. The enclosing cover part can be placed over the functional components and shields them from the surroundings. The particularly simple configuration of the housing cover part has been identified as one of the keys according to the invention for the compactness of the packaging material production machine.

According to a further aspect of the present invention, which can be combined with the preceding aspects and exemplary embodiments, a packaging material production machine for producing a packaging material product is provided.

The packaging material production machine according to the invention comprises a feed for introducing packaging material, in particular from a packaging material web wound up to form a roll from the inner side of the roll, into the packaging material production machine. The feed can have a deflection roller oriented transversely, in particular perpendicularly, to the insertion direction of the packaging material web and, if appropriate, a guide wall arranged at a lateral end, in particular end face, of the deflection roller for deflecting the packaging material web in the direction of the deflection roller. The deflection roller can be idle. For example, the deflection roller is not driven by a motor or a similar drive component, but rather rotates exclusively as a result of frictional contact with the packaging material deflected by the deflection roller. For example, in this case a particularly low-friction mounting for the deflection roller may be provided, for example by selecting a low-friction material pairing, by lubrication and/or by generating a lubricating film, in particular in the case of full lubrication. It is also possible for the deflection roller to be driven and/or to be used for conveying and drawing in the packaging material web into the packaging material production machine. Moreover, the deflection roller can also be arranged rigidly without a rotational degree of freedom of movement and can be realized for example by a particularly smooth surface, by means of which the frictional contact with the packaging material web to be deflected is particularly reduced.

The packaging material production machine according to the invention further comprises a shaping device, arranged downstream of the feed in the conveying direction, for shaping a packaging material web into a voluminous, cushioning packaging material product, in particular with at least one crumple cavity. The shaping device generally serves to shape a flat packaging material web or a tubular packaging material strand into a three-dimensional, cushioning and voluminous packaging material product.

Furthermore, the packaging material production machine comprises a dispensing device for dispensing the packaging material production product. The dispensing device may be designed as a tear-off device and/or cutting-to-length device which is capable of producing packaging material products, in particular of a desired length, or which can be used by an operator to tear off a packaging product of a certain length.

According to the further aspect according to the invention, the packaging material production machine according to the invention has a housing which receives, encloses or imposes on the shaping device and the dispensing device, and a power supply unit which is arranged in the housing. As a result of the fact that the power supply unit is integrated within the housing of the packaging material production machine, the packaging material production machine can be used in a particularly flexible manner and can be repositioned in a simple manner in particular on account of its compactness. In order to be able to put a packaging material production machine according to the invention into operation, it is thus only necessary to connect a power plug to the packaging material production machine. All the components necessary for the operation of the packaging material production machine, in particular the components thereof necessary for further power supply, are present in the packaging material production machine, in particular accommodated in the housing thereof.

The present invention further relates to a system comprising a packaging material production machine according to one of the previously described aspects and/or exemplary embodiments and a packaging material web wound up to form a roll, wherein the packaging material production machine is designed to draw packaging material from the inner side of the roll of packaging material web.

Moreover, the present invention relates to a method for operating a packaging material production machine according to one of the preceding claims and/or a system according to the invention.

Preferred embodiments are specified in the dependent claims.

Further properties, features and advantages of the invention will become clear below by means of a description of preferred embodiments of the invention on the basis of the accompanying exemplary drawings, in which:

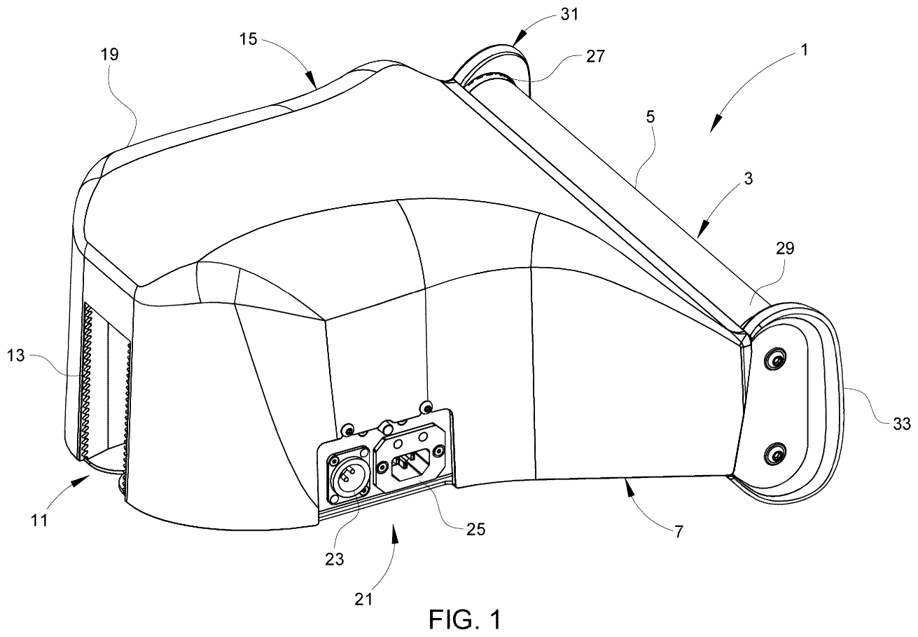

FIG. 1 shows a perspective view of an exemplary embodiment of a packaging material production machine according to the invention;

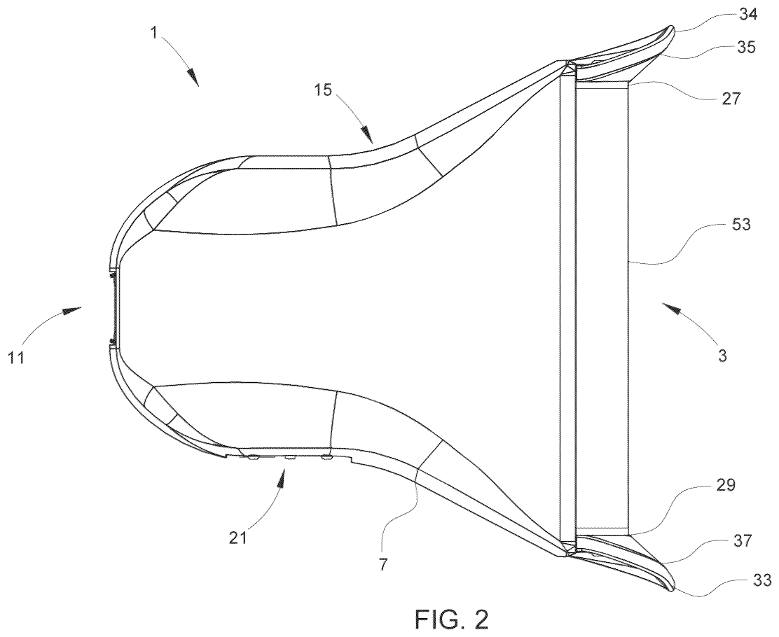

FIG. 2 shows a plan view of the packaging material production machine from FIG. 1;

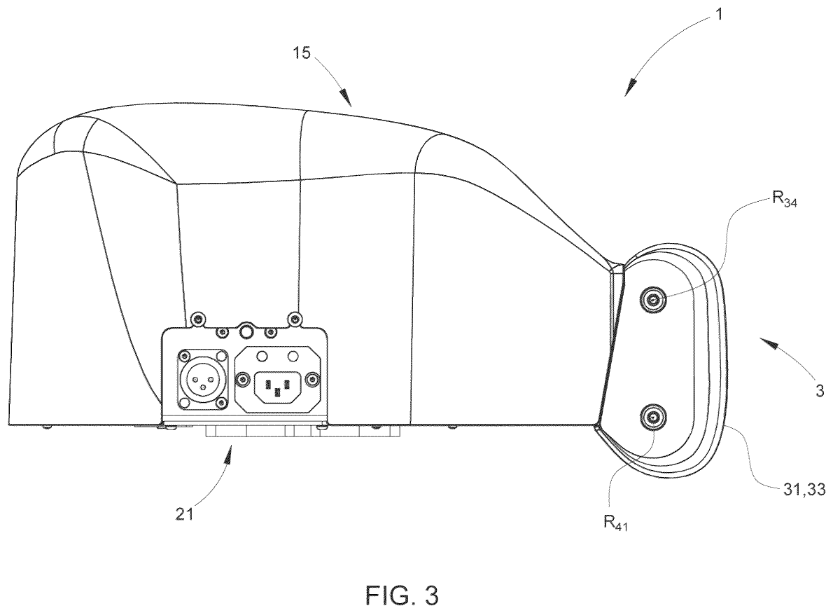

FIG. 3 shows a side view of the packaging material production machine from FIGS. 1 and 2;

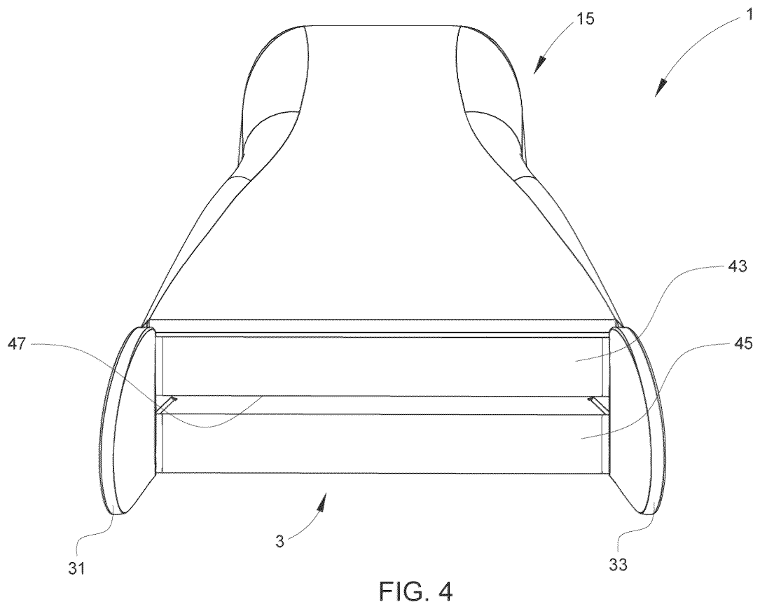

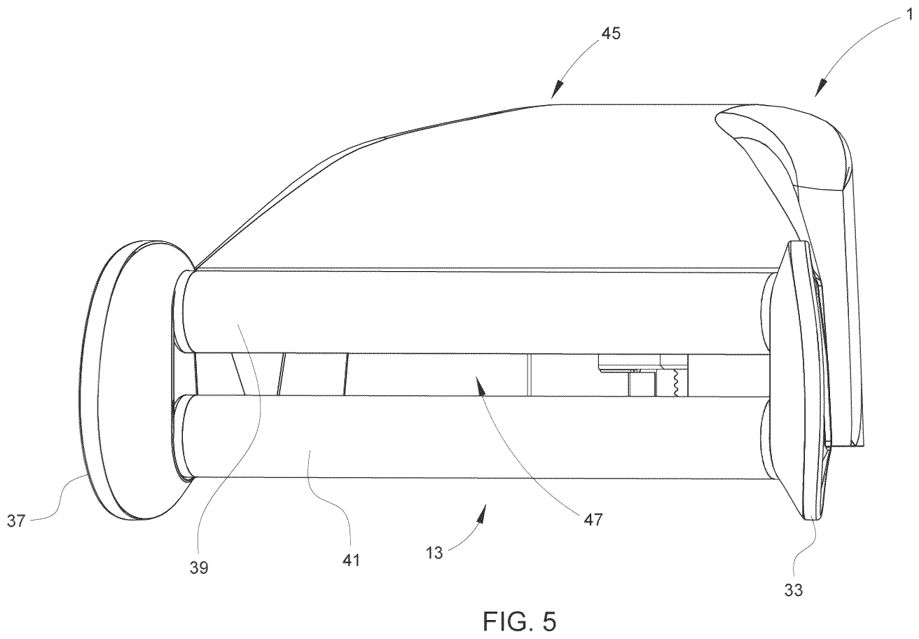

FIG. 4 shows a front view of a further exemplary embodiment of a packaging material production machine according to the invention, FIG. 5 shows a further front view of a further exemplary embodiment of a packaging material production machine according to the invention;

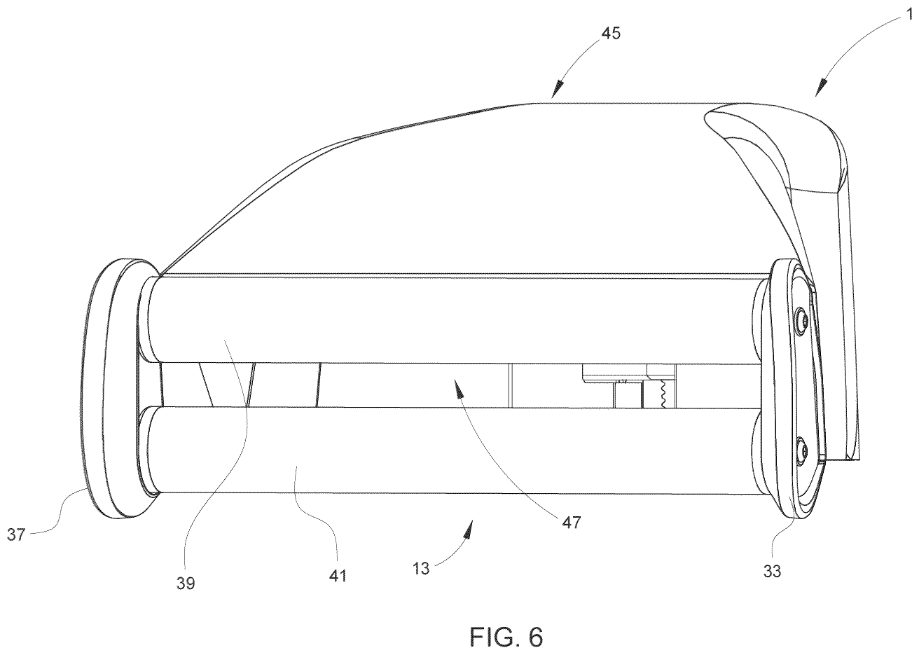

FIG. 6 shows a front view of a further exemplary embodiment of a packaging material production machine according to the invention;

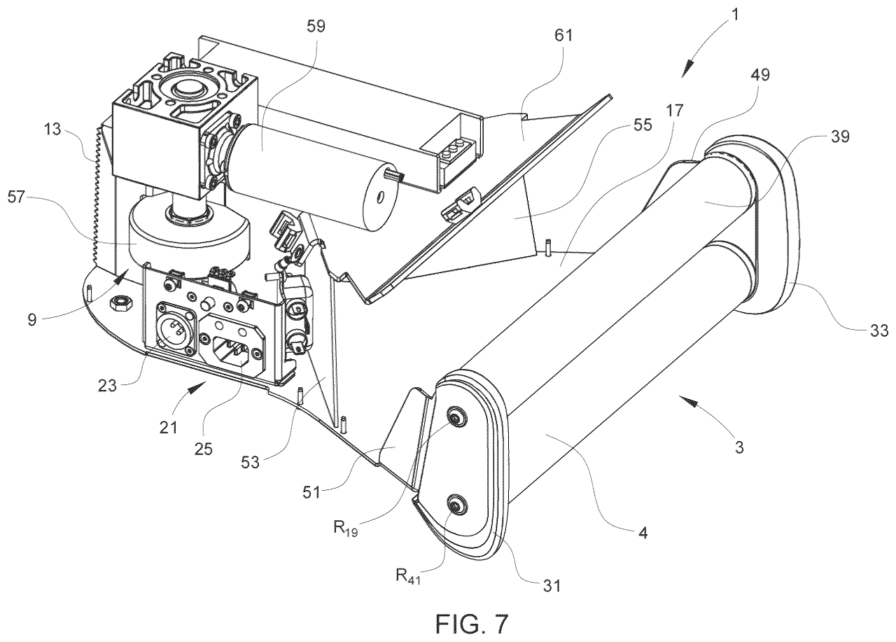

FIG. 7 shows a perspective internal view of the packaging material production machine from FIGS. 1 to 3;

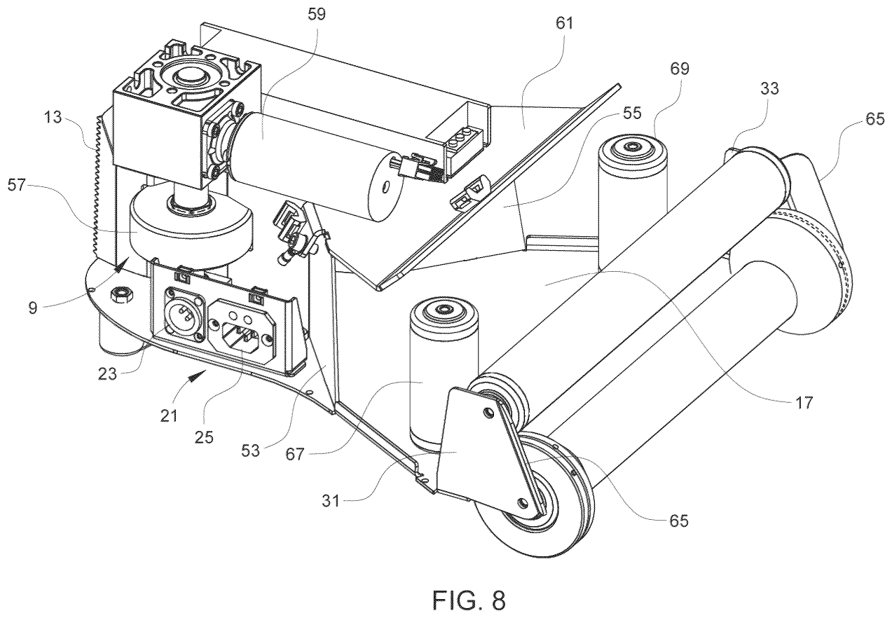

FIG. 8 shows a perspective internal view of a further exemplary embodiment of a packaging material production machine according to the invention;

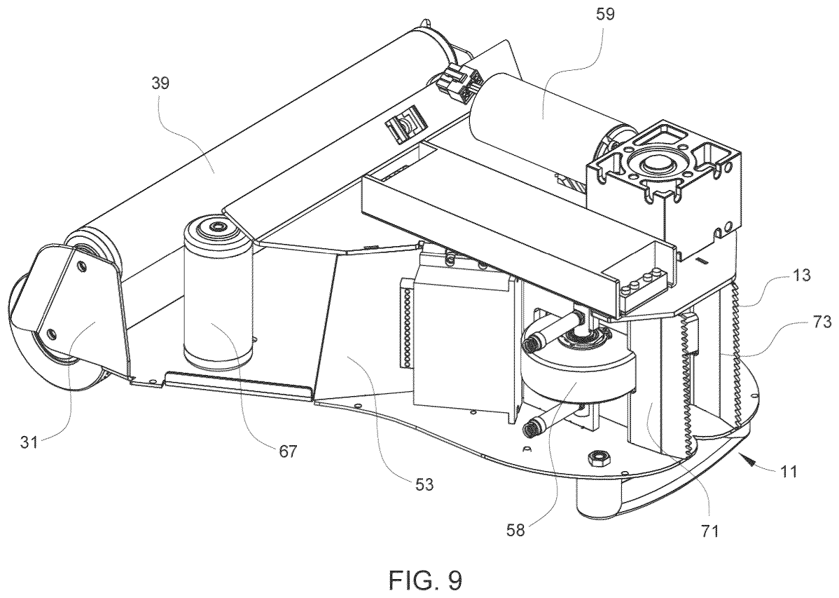

FIG. 9 shows a further perspective view of the packaging material production machine from FIG. 8;

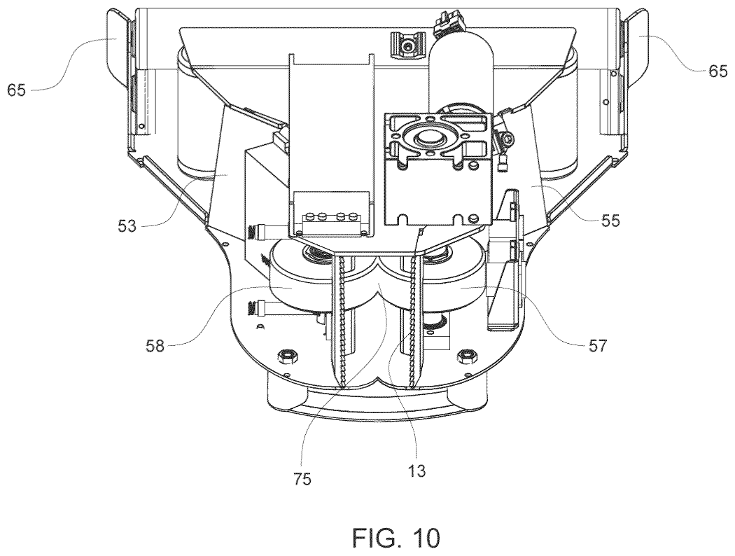

FIG. 10 shows a further perspective view of the packaging material production machine from FIG. 8;

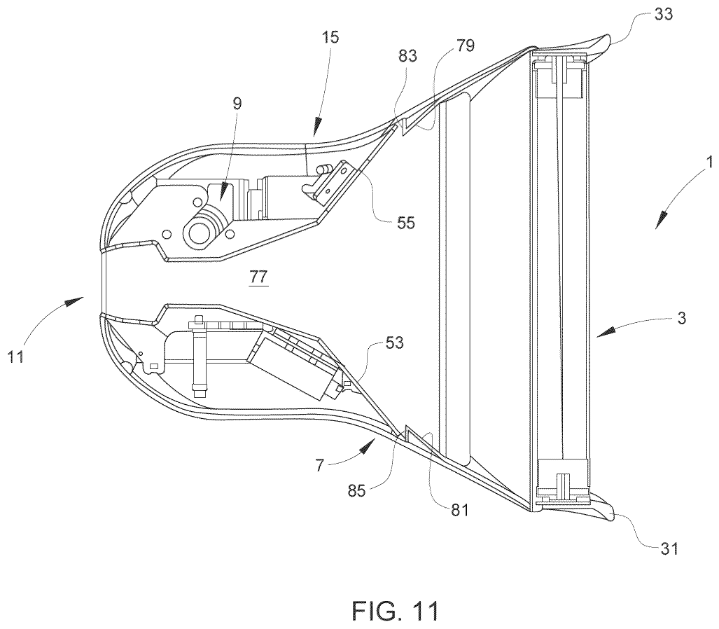

FIG. 11 shows a schematic plan view of the interior of a further exemplary embodiment of a packaging material production machine according to the invention; and

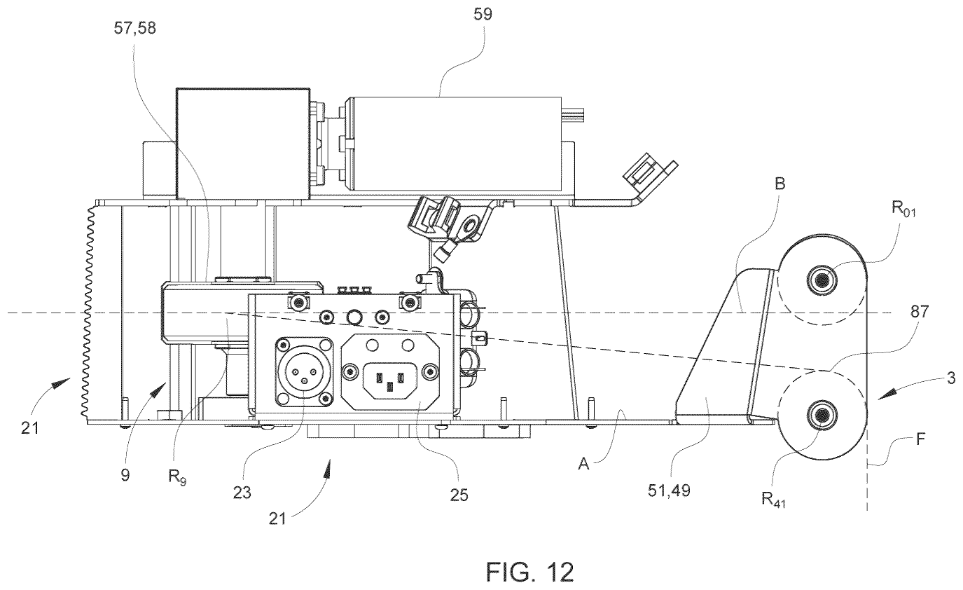

FIG. 12 shows a schematic basic sketch of the interior of a further exemplary embodiment of a packaging material production machine according to the invention.

In the following description of exemplary embodiments of the present invention, a packaging material production machine according to the invention is generally provided with the reference number 1. In the exemplary embodiments illustrated, it can be assumed that the packaging material is paper which has a web shape and is wound up to form a roll and is drawn off from the inner side of the roll by the packaging material production machine.

FIG. 1 shows a packaging material production machine 1 according to the invention according to an exemplary embodiment in a perspective view obliquely from the front, at the top. When reference is made to the front or rear, this is to be understood in relation to the conveying of the packaging material web, wherein the packaging material reaches the packaging material production machine at the rear and leaves it again at the front. The packaging material production machine 1 substantially comprises the following main components:

A feed 3 for introducing packaging material from a web-shaped packaging material supply (not illustrated) with a deflection roller 5 for the concerted introduction of the packaging material into the interior of the packaging material production machine 1; a feed funnel 7 which is arranged downstream of the feed in the conveying direction and which laterally delimits the guide path of the packaging material web and feeds it in a concerted manner to a shaping device 9 arranged downstream (FIG. 7); and a dispensing device and/or cutting-to-length device 11 which is arranged downstream of the shaping device 9 and at which a packaging material product which is produced can be removed and which has, for example, tear-off teeth 13 for tearing off a packaging material product strand.

The packaging material production machine 1 further comprises a housing 15 which encloses the components for the most part and which consists of a base part 17 (FIG. 7) which is produced in particular from one piece and a cover part 19 which is produced from one piece and which are fastened to one another. According to the exemplary embodiment from FIG. 1, an electronics point 21 with electronics connections 23, 25, in particular a power connection for a power supply plug, is arranged in the cover part 19 in order to supply power to a power supply unit which is accommodated within the housing 15. The feed 3 further comprises in each case one guide wall 31, 33 arranged at in each case one lateral end 27, 29 of the deflection roller 5, which guide wall is designed and shaped for deflecting the packaging material web in the direction of the deflection roller 5 and thus into the interior of the packaging material production machine 1.

The compactness of the packaging material production machine and the housing contour thereof can be seen substantially from the plan view from FIG. 2. The packaging material production machine has its widest region in the region of the feed 3 and, starting from the latter, tapers increasingly towards the dispensing device 11. Furthermore, it can be seen from FIG. 2 that the guide wall 33 projects beyond the extent of the deflection roller 5 counter to the conveying direction of the packaging material web. Furthermore, the guide wall 31, 33 comprises guide surfaces 35, 37 which are shaped convexly in the direction of the deflection roller 5 and are shaped for continuously feeding and deflecting the packaging material web to the deflection roller 5 and thus into the interior of the packaging material production machine 1.

A side view of the packaging material production machine 1 can be seen in FIG. 3. It can be seen substantially from the latter that the guide wall 31, 33 covers the deflection roller 5. The latter is therefore arranged in the wind shadow of the deflection roller 31, 33. Furthermore, it can be seen that the guide wall 31, 33 firstly projects beyond the roller counter to the conveying direction and secondly also projects beyond the extent of the deflection roller 5 in a direction oriented transversely thereto, in particular in the vertical direction, such that the guide wall can reliably deflect the packaging material web in a particularly flexible manner and independently of the position of the packaging material web to be conveyed. In the exemplary embodiment according to FIGS. 1-3 and 5-11, the guide 3 comprises a pair of rollers 39, 41 which form the deflection roller 5 and are mounted for example in a freely rotating manner, which is indicated by means of the rotation centers R 3₉ and R₄₁. These may, as can be seen by way of example in FIG. 3, be arranged one above the other in the vertical direction or else be arranged with respect to one another such that the roller 41 which is lower in relation to the vertical direction projects with respect to the roller 39 in relation to the conveying direction of the packaging material web.

FIG. 4 shows an exemplary embodiment of a packaging material production machine according to the invention in which the feed 3 has, instead of rotatably mounted rollers, rigid guide surfaces 43, 45 which between them form a conveying gap 47 through which the packaging material web can pass into the interior of the packaging material production machine 1.

FIGS. 5 and 6 show further exemplary embodiments of packaging material production machines according to the invention which differ from one another with regard to the feed 3. The difference between the two embodiments is with regard to the dimensioning of the lateral guide walls 31, 33 which are dimensioned significantly smaller in FIG. 6 than in FIG. 5. It is common to both embodiments that the guide wall 31, 33 covers a lateral end section of the rollers 39, 41 and in particular a bearing gap which exists between a lateral housing wall of the packaging material production machine, on which the rollers 39, 41 are mounted, and a lateral end face end of the rollers 39, 41. As a result, it can be avoided that packaging material becomes entangled or loses in the region of the bearing gap.

FIGS. 7 to 10 show various embodiments and views of a packaging material production machine in which the cover part 15 is omitted. A further essential aspect of the present invention emerges therefrom, according to which all the functional components of the packaging material production machine 1 are arranged or fastened to the base part 17 and are supported by the latter. Arranged downstream of the feed 3 in the conveying direction are lateral delimiting walls 49, 51 which serve for additionally guiding the packaging material web. Provided again downstream of the conveying direction are funnel wall sections 53, 55 which, according to FIG. 7, are arranged at a distance from the delimiting walls 51, 49 in the conveying direction, but also merge into the latter or can be formed integrally therewith. The funnel wall sections 53, 55 delimit between them a conveying path which increasingly and in particular continuously tapers or reduces in size in order to finally feed the packaging material to be processed centrally to the shaping device 9.

The shaping device 9 has a pair of conveying wheels 57, 58, of which one conveying wheel 57 can be seen in FIG. 7. The conveying wheel 57 is driven by a motor-gear arrangement 59 in order to actively convey the packaging material and in particular to draw it off the packaging material supply. Furthermore, provided in the region of the funnel wall sections 53, 55 is a funnel cover 61 which delimits the conveying path upwards opposite the base part 17. The funnel cover 61 can also extend counter to the conveying direction to approximately the level of the feed 3.

The embodiment according to FIG. 8 differs from the embodiment according to FIG. 7 firstly with regard to the feed 3. According to FIG. 8, the feed likewise has a roller pair, wherein the lower roller 41 is offset counter to the conveying direction in relation to the upper roller 39. This is indicated by an angle α which is defined between a vertical V and a connecting line A between the rotation axes R₃₉ and R₄₁. Furthermore, the guide wall 31, 33 according to FIG. 8 is equipped with a deflection funnel wall section 63, 65 which ensures that packaging material leading laterally past the feed 3 is nevertheless guided toward the roller pair 39, 41.

Furthermore, provided for additionally tapering the conveying path downstream of the feed and at a directly adjacent distance from the feed 3 is a pair of in particular free-running conveying rollers 67, 69 with a vertical rotation axis, on which the packaging material is additionally deflected in a concentrated manner in the direction of the center.

FIG. 9 shows a rear view of the embodiment of the packaging material production machine according to FIG. 8 and shows the second conveying wheel 58 of the conveying wheel pair of the shaping device 9. The dispensing device 11 comprises two shaft walls 71, 73 which stand substantially perpendicularly to the conveying direction and the leading edges of which are shaped for forming tear-off teeth 13.

FIG. 10 belongs to the embodiment of the packaging material production machine according to FIGS. 8 and 9 and shows the conveying wheels 57, 58 of the shaping device 9 rolling against one another. As a result of the rolling contact, which is indicated by the reference symbol 75, packaging material can be conveyed reliably and constantly through the packaging material production machine and thus packaging material products can be produced which can finally be removed via the dispensing device 11.

FIG. 11 shows schematically the conveying path, which is indicated by means of the reference symbol 77, of the packaging material web through the packaging material production machine 1. According to the exemplary embodiment from FIG. 11, downstream of the feed 3 and upstream of the funnel wall sections 53, 55 in the conveying direction, a further funnel section is formed from two opposite housing walls 79, 81 which form a constricted channel section by forming in each case one shoulder 83, 85. As a result of this, a reliable transfer of the packaging material web to the funnel walls 53, 55 is ensured.

FIG. 12 shows schematically a horizontal configuration of the packaging material production machine 1, in which a horizontal line is indicated by the operating symbol H. As can be seen from FIG. 12, the feed 3 is arranged in relation to the remaining components, in particular the shaping device 9 and in particular the conveying wheel 57, 58 thereof, such that an angle β is produced between the horizontal H and a conveying path line F which indicates the conveying direction. As is shown in the figure, the packaging material web is conveyed towards the lower deflection roller and partially deflected by the latter before the packaging material leaves the roller 41 at a contact end point 87. connecting line between the contact end point 87 and a rotation center R₉ of the deflection device is present at an angle β in the range from more than 0° to at most 10° in relation to the horizontal H.

Furthermore and in addition to the aspects and embodiments of the packaging material production machine 1 mentioned at the outset, a tip of the at least one tear-off tooth 13 is arranged so as to protrude inwards with respect to an outer contour of the housing 15. According to the embodiment according to FIG. 2, each tear-off tooth 13 together with its tip is arranged so as to be flush with the outer contour of the housing 15 and/or does not protrude outwards beyond the silhouette of the housing 15. In another and advantageous manner, the tear-off teeth 13 jump by a few millimeters, preferably by 2, 3 or 5 millimeters, including the respective tear-off tooth tip counter to the conveying direction F into the interior of the housing 15, with the result that the manual handling of the packaging material production machine 1 is improved.

As can be seen from the figures, in particular from FIG. 2, the tear-off device and/or cutting-to-length device has two rows of tear-off teeth 13 which are at a distance from one another. The clear width between the rows of tear-off teeth 13 is smaller than the clear width of the housing opening which corresponds to the tear-off device and cutting-to-length device or to the dispensing device 11. In an advantageous manner, therefore, firstly the tips of the tear-off teeth 13 jump into the housing interior, while secondly the packaging material itself is also reliably seized and severed by the tear-off teeth 13 when the strand of the packaging material is pulled very strongly at an angle of more than 70 degrees and obliquely to the side in relation to the conveying direction F.

Furthermore and in addition to the aspects and embodiments of the packaging material production machine 1 mentioned at the outset, the flexibility in the material selection should also be mentioned. Because the essential basic elements of the packaging material production machine 1 are designed as sheet-metal elements, the possibility is given of using different materials. According to an exemplary embodiment of the packaging material production machine 1, steel components are used. These can be connected to one another in a material-bonded and/or form-fitting manner and offer the advantage of sovereign robustness with optimization of the wall thicknesses. According to a further embodiment of the packaging material production machine 1, aluminium components are used and offer the advantage of weight optimization. According to another embodiment of the packaging material production machine 1, plastic components are used which offer advantages such as optimization in terms of production engineering if they are thermally shaped or preformed. According to another conceivable embodiment of a packaging material production machine 1, different materials are used which are now connected to one another according to a form-fitting and/or material-bonded (adhesive) joining method in relation to the material-bonded joining methods.

Furthermore, it should also be mentioned that, in an advantageous development of the embodiment mentioned at the outset, the guide wall 31, 33 and also the delimiting wall 49, 51 and also the funnel wall section 53, 55 are connected to one another and/or form an integral molded part or form a molded part composed of a plurality of parts. Overall, the stability of the packaging material production machine 1 is improved as a result.

The features disclosed in the preceding description, the figures and the claims can be significant both individually and in any desired combination for the realization of the invention in the various configurations.

### REFERENCE SIGN LIST

1 Packaging material production machine
3 Feed
5 Deflection roller
7 Funnel section
9 Shaping device
11 Dispensing device
13 tear-off tooth
15 housing
17 Base part
19 Ceiling part
21 Electronics interface
23, 25 Electronics connection
27, 29 End sections
31, 33 guide wall
35, 37 guide surface
39, 41 roller
43, 45 Deflection wall section
47 Feedthrough gap
49, 51 delimiting wall
53, 55 Funnel wall section
57, 58 conveying wheel
59 Geared motor arrangement
61 funnel cover
63, 65 Funnel wall section
67, 69 deflection roller
71, 73 Channel wall
57 rolling contact
77 conveying path
79, 81 Funnel wall
83, 85 shoulder
87 contact end point
H horizontal direction
F conveying direction
α, β angle
V vertical direction
Rᵢ Rotation axis of component i

1. A packaging material production machine for producing a packaging material product, the packaging material production machine comprising:
a feed for introducing packaging material from an inner side of a wound roll of a packaging material web wound with a deflection roller oriented transversely and perpendicularly to a conveying direction of the packaging material web into the packaging material production machine; and
a guide wall disposed at an end face of a lateral end of the deflection roller for deflecting the packaging material web in a direction of the deflection roller.

2. The packaging material production machine of claim 1, wherein the lateral end is covered by the guide wall in the conveying direction of the packaging material web.

3. The packaging material production machine of claim 1, wherein the deflection roller is mounted on a shaft supported laterally on a housing wall, and a bearing gap is positioned between the housing wall and the end face of the lateral end of the deflection roller, wherein the bearing gap is covered by the guide wall.

4. The packaging material production machine of claim 1, wherein the guide wall delimits a guide path which tapers in a funnel-like manner at least in sections in the conveying direction of the packaging material web.

5. The packaging material production machine of claim 1, wherein the guide wall extends beyond the deflection roller opposite the conveying direction of the packaging material web.

6. The packaging material production machine of claim 1, wherein the guide wall has a cross section shaped such that the guide wall follows a circle segment of at least 90° of a cross section of the deflection roller.

7. The packaging material production machine of claim 1, wherein the deflection roller consists of a pair of rollers delimiting a passage gap for the packaging material web, wherein the guide wall is configured to deflect the packaging material web in a direction of the passage gap.

8. The packaging material production machine of claim 7, wherein the guide wall covers a lateral end section of the pair of rollers in the conveying direction of the packaging material web.

9. The packaging material production machine of claim 1, further comprising:
a forming device arranged downstream of the deflection roller in the conveying direction, the forming device configured to form the packaging material web into an upholstering packaging material product, wherein an orientation of a conveying path from the deflection roller to the forming device is inclined with respect to a delivery direction of the packaging material product downstream of the forming device at an angle not greater than 10°.

10. The packaging material production machine of claim 9, wherein the forming device has a pair of conveying wheels rolling against one another, the pair of conveying wheels mounted rotatably with respect to an axis of rotation oriented perpendicularly to the delivery direction, and the angle is determined based on a contact end point, at which the packaging material web leaves the deflection roller, to a center of rotation of the pair of conveying wheels.

11. The packaging material production machine of claim 9, wherein the packaging material production machine is configured in a horizontal configuration in which the delivery direction is oriented horizontally and the conveying path is inclined, and the conveying path, starting from a contact end point, at which the packaging material web leaves the deflection roller, to a center of rotation of the pair of conveying wheels bridges a height difference in a range from 15 millimeters (mm) to 50 mm.

12. The packaging material production machine of claim 1, further comprising a guide device arranged downstream of the deflection roller, the guide device defining a reduced guide path for the packaging material web shorter than a length of the deflection roller, the guide device disposed at a distance not greater than twice a deflection roller diameter from the deflection roller in the conveying direction of the packaging material web.

13. The packaging material production machine of claim 12, wherein the guide device is formed by a pair of guide rollers arranged at a distance from one another, the pair of guide rollers defining an axis of rotation oriented transversely and perpendicularly to an axis of rotation of the deflection roller.

14. A system, comprising:
a roll of packaging material web; and
a packing material production machine comprising:
a feed for introducing packaging material from an inner side of the roll with a deflection roller; and
a guide wall configured to deflect the packaging material web in a direction of the deflection roller.

15. A method for operating a packaging material production machine, the method comprising:
introducing, via a feed and along a conveying direction, a roll of packaging material web into a packaging material production machine;
directing, via a guide wall, the packaging material web from the feed to a deflection roller, the deflection roller oriented transversely to the conveying direction.

16. The packaging material production machine of claim 6, wherein the circle segment is one of at least 135°, at least 180°, at least 225°, or at least 270°.

17. The packaging material production machine of claim 9, wherein the upholstering packaging material product has at least one crumple cavity.

18. The packaging material production machine of claim 9, wherein the angle is not greater than 7°.

19. The packaging material production machine of claim 10, wherein the pair of conveying wheels comprises a meshing pair of embossing wheels.

20. The packaging material production machine of claim 11, wherein the height difference is in a range from 20 mm to 40 mm.
